(19) United States
(12) Patent Application Publication
(10) Pub. No.: US 2022/0242664 A1
(43) Pub. Date: Aug. 4, 2022

(54) AUTOMATED SYSTEM FOR HANDLING CONTAINERS

(71) Applicant: LHD S.P.A., Bruino (IT)

(72) Inventor: Giuliano RIVOIR, Bruino (IT)

(21) Appl. No.: 17/724,767

(22) Filed: Apr. 20, 2022

Related U.S. Application Data
(63) Continuation of application No. PCT/IT2020/050235, filed on Sep. 28, 2020.

(30) Foreign Application Priority Data
Oct. 25, 2019 (IT) 102019000019802

(51) Int. Cl. B65G 1/04; B66F 9/12

(52) U.S. Cl. CPC B65G 1/0435; B66F 9/122

(57) ABSTRACT

An automated system (1) for handling containers is described, comprising a vertically arranged telescopic fork (10) which comprises a fixed base (5) and at least one slider (20, 30) telescopically sliding with respect to the fixed base (5) on a series of rollers (14) which support the at least one slider (20, 30), further comprising thrusting means (21) driven by actuators (22) and configured for thrusting the containers inside a shelving, or for removing them, following the movement of the slider (20, 30) to which they are connected, the automated handling system (1) further comprising a supplying system (15), installed on the slider (30) to electrically supply the actuators (22) of the thrusting means (21), the supplying system (15) comprising energy accumulating means (16) configured to store the electric energy for supplying the electric moto-reducers (22).

### BACKGROUND OF THE INVENTION

### 1) Field of the Invention

The present invention refers to an automated system for handling containers, in particular for handling plastic or cardboard boxes in the field of automatic warehouses.

More in particular the invention refers to a telescopic system, typically associated with a translating-lifting device to store or withdraw containers in or to shelving.

### 2) Background Art

Telescopic systems, for example telescopic forks, are known in the art and comprise thrusting means configured for thrusting containers in the shelving, or for withdrawing them, driven by actuators comprising electric moto-reducers which are installed on the telescopic system.

In order to electrically supply such actuators, electric cables are used which, to be adapted to the elongation of the telescopic system, are usually contained inside catenary-type cable holders, which catenary extends when the telescopic system is extended, while is bent when the telescopic system is retracted.

Known automated systems for handling containers however suffer from some inconveniences, as regards the length and overall sizes of the catenary cable holder.

In particular, while a telescopic system typically has a life of about 3 million cycles, a catenary cable holder made of plastics has a much shorter life, being capable of arriving at a maximum of 100,000 cycles before being replaced.

Moreover, the catenary cable holder has vertical lateral overall sizes which increase the encumbrance of the telescopic system, increasing the minimum distance which must be kept between two contiguous shelves, preventing to optimize the sizes of the automatic warehouse in case of containers with smaller sizes. For example, typical sizes of a telescopic system are 40×180 mm, which becomes 50×200 mm taking into account the encumbrance of the catenary cable holder. So that the minimum height of the shelf will be about 200 mm, with a waste of space when boxes with a smaller height must be stored.

CA-A1-2 288 535 discloses an automated system according to the preamble of claim 1.

### SUMMARY OF THE INVENTION

Object of the present invention is solving the above prior art problems, by providing an automated system for handling containers which is reliable and with small overall sizes.

The above and other objects and advantages of the invention, as will result from the following description, are obtained with an automated system for handling containers as claimed in the independent claim.

Preferred embodiments and non-trivial variations of the present invention are the subject matter of the dependent claims.

It is intended that the enclosed claims are an integral part of the present description.

It will be immediately obvious that numerous variations and modifications (for example related to shape, sizes, arrangements and parts with equivalent functionality) could be made to what is described, without departing from the scope of the invention, as included in the enclosed claims.

### BRIEF DESCRIPTION OF THE DRAWINGS

The present invention will be better described by some preferred embodiments thereof, provided as a non-limiting example, with reference to the enclosed drawings, in which:

FIG. 1 shows a perspective view of an automated system for handling containers according to the invention; and

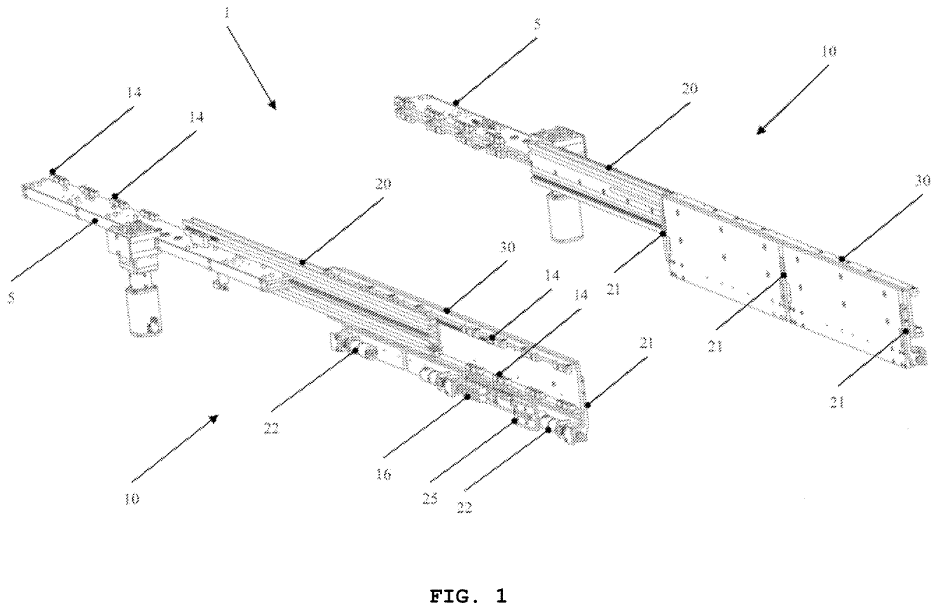

FIG. 2 shows a perspective view of an enlarged part of an automated system for handling containers according to the invention.

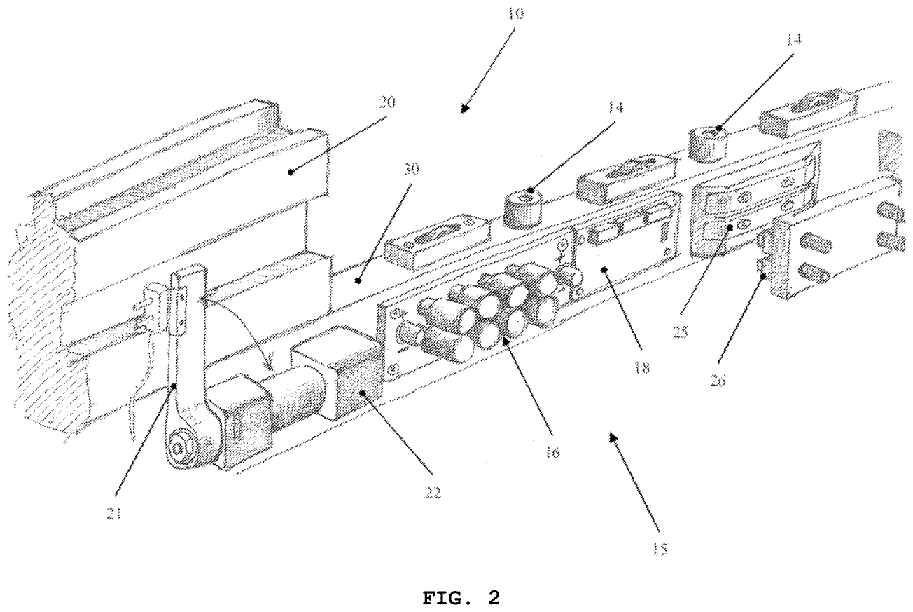

### DETAILED DESCRIPTION OF PREFERRED EMBODIMENTS

With reference to the Figures, a preferred embodiment of the automated system 1 for handling containers according to the present invention, is shown and described, the system 1 comprising a telescopic fork 10 of a known type, vertically arranged and comprising a fixed base 5 and at least one slider, or moving element 20, 30 telescopically sliding with respect to the fixed base 5 on a series of rollers 14 with vertical axis, connected to the base 5 and/or to the slider 20, 30, which support the at least one slider 20, 30, further comprising thrusting means 21 driven by actuators 22 and configured for thrusting the containers inside a shelving, or for withdrawing them, following the movement of the slider 20, 30 to which they are connected.

Preferably, the automated system 1 for handling containers according to the present invention comprises two telescopic forks 10 vertically arranged and mutually facing, spaced by a space useful to house a container to be thrusted in a shelving, or to withdraw it through the thrusting means 21.

The telescopic fork 10 of the automated system 1 for handling containers according to the present invention comprises, in a preferred way, an intermediate slider 20 with respect to the fixed base 5, telescopically sliding on a first series of rollers with vertical axis, supported for example by the fixed base 5, and an end slider 30, telescopically sliding with respect to the intermediate slider 20 on a second series of rollers 14 with vertical axis, supported for example by the end slider 30, which further comprises the thrusting means 21 configured for thrusting the containers in the shelving.

The actuators 22, for example electric moto-reducers, are connected to the end slider 30 and the thrusting means 21 preferably comprise at least one rod, configured to project from the end slider 30, for example following a rotation by 90° around a longitudinal axis, with respect to the telescopic movement of the fork, which passes it from a vertical position, which does not project from the end slider 30, to a horizontal position, projecting from the end slider 30, which allows getting the rod 21 in contact with the container to thrust and store it on the shelf, following the telescopic sliding of the end slider 30 to which it is connected.

The end slider 30 can be, for example, a first slider or a second slider, respectively when the telescopic fork 10 of the automated handling system 1 comprises one or two telescopic sliders.

The automated handling system 1 of the invention further comprises a supplying system 15, installed on the slider, preferably on the end slider 30, to electrically supply the actuators 22 of the thrusting means 21; the supplying system 15 comprising energy accumulating means 16, for example installed on an electronic card, preferably a battery of capacitors 16, configured to store the electric energy to supply the electric moto-reducers 22, for example to provide the necessary power to supply ten rotation cycles of the at least one rod 21.

In a preferred way, the supplying system 15, in particular the electronic card, further comprises sliding contacts 25 of a known type to connect the energy accumulating means 16 to an external electric supply 26, in particular also comprising the sliding contacts, in order to re-charge them when the slider goes back to its initial position, with the telescopic fork 10 retracted.

The supplying system 15, in particular the electronic card, further comprises a wireless connecting module 18, for example of the Bluetooth type, configured to transmit the commands to the actuators 22 of the thrusting means 21.

The automated handling system 1 of the invention further comprises actuating means of the sliders 20, 30 of a known type, for example comprising chains and/or rack-type mechanisms configured to transfer the motion from motor means to the sliders 20, 30, and a control system of the motor means, of the position or of the limit stroke of the sliders 20, 30, comprising a logic control unit, also known.

Advantageously, the automated handling system of the invention allows making a reliable system, with a life of three million cycles, with reduced overall sizes, which allow recovering useful space between the shelves of the automated handling system, which allows in particular to optimize the space for containers with reduced sizes.

We claim:

1. An automated system for handling containers comprising: a vertically arranged, telescopic fork which comprises a fixed base and at least one slider telescopically sliding with respect to the fixed base on a series of rollers which support the at least one slider, further comprising thrusting means driven by actuators and configured for thrusting the containers inside a shelving, or for extracting them, following the movement of the slider to which they are connected, the automated handling system further comprising a supplying system, installed on the slider to electrically supply the actuators of the thrusting means, the supplying system comprising energy accumulating means configured to store the electric energy for supplying the electric moto-reducers, wherein the actuators are connected to the slider and the thrusting means comprise at least one rod configured to project from the end slider which pass them from a first position, which does not project from the slider, to a second projecting position which allows getting the rod in contact with the container to thrust and store it in the shelf, following the telescopic sliding of the slider to which it is connected.

2. The automated system for handling containers of claim 1, wherein the supplying system further comprises sliding contacts configured to connect the energy accumulating means to an external electric supply, in order to re-charge them when the slider goes back to its initial position, with the telescopic fork retracted.

3. The automated system for handling containers of claim 1, wherein the energy accumulating means are a battery of capacitors.

4. The automated system for handling containers of claim 1, comprising two telescopic forks, vertically arranged and mutually facing, spaced by a space useful to house a container to be thrust in a shelving, or to remove it therefrom through the thrusting means.

5. The automated system for handling containers of claim 1, wherein the actuators are electric moto-reducers.

6. The automated system for handling containers of claim 1, wherein the rod is configured to project from the end slider following a rotation around a longitudinal axis with respect to the telescopic movement of the fork.

7. The automated system for handling containers of claim 1, further comprising a wireless connecting module configured for transmitting the commands to the actuators of the thrusting means.

8. The automated system for handling containers of claim 1, wherein the telescopic fork comprises an intermediate slider, telescopically sliding on a first series of rollers with respect to the fixed base, and an end slider, telescopically sliding on a second series of rollers with respect to the intermediate slider, the actuators being connected to the end slider which further comprises the supplying system and the thrusting means configured for thrusting the containers in the shelving.
